(19) United States
(12) Patent Application Publication
(10) Pub. No.: US 2007/0225445 A1
(43) Pub. Date: Sep. 27, 2007

(54) Extrusion coating composition

(75) Inventors: Lan Thi Nguyen, Flower Mound, TX (US); James Arthur Auger, Calgary (CA)

Correspondence Address: KENNETH H. JOHNSON, P.O. BOX 630708, HOUSTON, TX, 77263, US

(73) Assignee: NOVA Chemicals (International) S.A.

(21) Appl. No.: 11/505,021

(22) Filed: Aug. 16, 2006

(30) Foreign Application Priority Data
Mar. 23, 2006 (CA) 2,541,180

(51) Int. Cl. C08L 23/04

(52) U.S. Cl. 525/240

(57) ABSTRACT

Disclosed are polymer blends composed of from 25 to 75 wt % of ethylene homopolymer produced in a high pressure tubular reactor and from 75 to 25 wt % of ethylene homopolymer produced in a high pressure autoclave reactor, provided that each homopolymer is removed from the reaction zone prior to being blended together. The blends so formed have a good combination of neck-in and adhesion properties. A process for the extrusion coating of a substrate with these new polymer blends is also described.

### FIELD OF THE INVENTION

The current invention relates to polymer blend compositions that are useful for application in extrusion coating processes. The polymer blends have a good balance of neck-in and adhesion values at useful drawdown rates.

### BACKGROUND TO THE INVENTION

To be useful in extrusion coating applications, ethylene polymers should have a balance of low neck-in, high drawdown and strong adhesion properties. Low density polyethylene (LDPE), which typically has a density range of from 0.91 to 0.94 g/cc and which is most commonly prepared by free radical polymerization in either a tubular reactor or an autoclave reactor, is often used for extrusion coating applications due to its good neck-in and drawdown rate properties.

Without wishing to be bound by theory, the following general differences between polyethylene made in an autoclave reactor and a polyethylene made in a tubular reactor are discussed. Due to the broad residence time distributions, polyethylene made in an autoclave reactor typically has a larger proportion of high molecular weight polymer and long chain branching relative to polyethylene made using a tubular reactor, where residence time distributions are comparably narrower. As a consequence, autoclave LDPE generally has superior neck-in properties. In contrast, tubular reactors provide LDPE with good adhesion properties due in part to a higher proportion of low molecular weight polymer.

For resins applied to an extrusion coating process there remains a need for methods, which further improve the balance of neck-in and adhesion characteristics.

In U.S. Pat. No. 4,496,698 a process is described in which ethylene is partially polymerized in an autoclave reactor, passed through a heat exchanger and then further polymerized in a tubular reactor. By using autoclave and tubular reactors in series, a low-density polyethylene with characteristics representative of each reactor type may be produced. The polyethylene resins so formed, which have a high drawdown and a low neck-in, are useful in extrusion coating applications. However, the disclosure teaches nothing about improved adhesion properties.

Alternatively, high drawdown rates and good neck-in values can be achieved by co-extrusion of LDPE with linear low-density polyethylene (LLDPE). U.S. Pat. Nos. 5,863,665 and 5,582,923 disclose an extrusion polymer blend composed of 75-95 wt % of a linear low density ethylene/α-olefin interpolymer and 5-25 wt % of a high pressure, low density ethylene polymer, which is useful for application in extrusion coating processes. U.S. Pat. No. 4,339,507 discloses a similar process for the extrusion coating of a substrate but with a polymer blend containing from 20 to 98 wt % of a high pressure, low density polyethylene homopolymer or copolymer and from 2 to 80 wt % of a linear low density ethylene copolymer.

The present invention provides polymer blends that have a good combination of neck-in and adhesion properties at high drawdown rates. The polymer blends have zero to low levels of antioxidant present to further improve performance in extrusion coating applications.

The inventive polymer blends are prepared by physically blending an ethylene homopolymer produced in a tubular reactor with an ethylene homopolymer produced in an autoclave reactor. Tandem reactor systems or reactors in series are not required for the current invention. The current invention avoids the expense and time required to design, construct and operate elaborate mixed reactor systems while still providing resin with good neck-in and adhesion properties.

An extrusion coating process, using the inventive polymer blends is also described.

### SUMMARY OF INVENTION

Polymer blends comprising 75-25 wt % of an ethylene homopolymer produced in a tubular reactor and 25-75 wt % of an ethylene homopolymer produced in a stirred autoclave reactor; wherein the ethylene homopolymer produced in each reactor is removed from the reaction zone prior to being blending together.

The polymer blends may have a neck-in value of 2.0-5.0 cm at a line speed of 150 ft/min, an adhesion value equal to or greater than 30 pounds per square inch gauge pressure (psig) at a line speed of 150 ft/min and may contain zero or low levels of an antioxidant. Reduced levels of antioxidant may be used to improve performance in extrusion coating applications.

The polymer blends contain from 75-25 wt % of an ethylene homopolymer produced in a tubular reactor which may have a melt index of from 4-10 g/10 min, a density of 0.914-0.93 g/cc, a polydispersity, M_{w}/Mₙ of 8 or more, and 0-500 ppm of an antioxidant.

The polymer blends contain from 25-75 wt % of an ethylene homopolymer produced in a stirred autoclave reactor, which may have a melt index of from 3-9 g/10 min, a density of at least 0.91 g/cc and a polydispersity, M_{w}/Mₙ of at least 10.

A process for the extrusion coating of a substrate with polymer blends of the current invention is also contemplated.

### DETAILED DESCRIPTION OF THE PREFERRED EMBODIMENTS

Polymer blends of the current invention are comprised of 75-25 wt % ethylene homopolymer that is produced in a tubular reactor and 25-75 wt % ethylene homopolymer that is produced in a stirred autoclave reactor. The term “ethylene homopolymer” is meant to describe a polymeric compound prepared by polymerizing ethylene monomer exclusively. Optionally, the ethylene homopolymers produced in each of a tubular reactor and an autoclave reactor may contain trivial amounts of another comonomer. The polymer blends are prepared by physically blending the ethylene homopolymer produced in a tubular reactor with the ethylene homopolymer produced in an autoclave reactor.

Physically blending is meant to encompass those processes in which two or more individual ethylene homopolymers are mixed after they are removed from a polymerization reaction zone. Physically blending of the individual ethylene homopolymers may be accomplished by dry blending (e.g. tumble blending), extrusion blending (co-extrusion), solution blending, melt blending or any other similar blending technique known to those skilled in the art.

The ethylene homopolymers of the current invention are prepared by free radical polymerization of ethylene in either a tubular reactor or an autoclave reactor.

A tubular reactor operates in a continuous mode and at high pressures and temperatures. Typical operating pressures for a tubular reactor are from 2000-3500 bar. Operating temperatures can range from 140° C.-340° C. The reactor is designed to have a large length to diameter ratio (from 400-40,000) and may have multiple reaction zones, which take the shape of an elongated coil. High gas velocities (at least 10 m/s) are used to provide optimal heat transfer. Conversions for multi-zone systems are typically 22-30% per pass but can be as high as 36-40%. Tubular reactors may have multiple injection points for addition of monomer or initiators to different reaction zones having different temperatures.

An autoclave reactor will have a length to diameter ratio of between 2 and 20 and may be single stage or multistage. Typically, low temperature ethylene is passed into a hot reaction zone and conversion may be controlled by the temperature differential between the incoming ethylene gas and the temperature of the autoclave reactor. Conversions are usually lower in an autoclave reactor, up to 23% per pass, than in a tubular reactor which has a higher capacity to remove the heat of polymerization. Typical operating pressures for autoclave reactors are from 1,100-2000 bar. Average operating temperatures are from 220-300° C., but temperatures can be as high as 340° C.

Although test procedures known in the art, such as gel permeation chromatography with viscometry detection (GPC-visc), capillary rheology and temperature rising elution fractionation (TREF) may help to distinguish between polyethylene made in a tubular reactor and polyethylene made in an autoclave reactor, in the preferred embodiment of the present invention, the ethylene homopolymers used in the polymer blends will be unequivocally identified by a commercial supplier as being made either in a tubular reactor or in an autoclave reactor.

A wide variety of initiators may be used with each type of reactor to initiate the free radical polymerization of ethylene. Initiators may include oxygen or one or more organic peroxides such as but not limited to di-tert-butylperoxide, cumuyl peroxide, tert-butyl-peroxypivalate, tert-butyl hydroperoxide, benzoyl peroxide, tert-amyl peroxypivalate, tert-butyl-peroxy-2-ethylhexanoate, and decanoyl peroxide. Chain transfer reagents may also be used with each type of reactor to control the polymer melt index. Chain transfer reagents include but are not limited to propane, n-butane, n-hexane, cyclohexane, propylene, 1-butene, and isobutylene.

The ethylene homopolymers of the current invention may have densities in the range of 0.91-0.94 g/cc as measured according to the procedure of ASTM D-792 and are generally known as low density polyethylenes (LDPE) in the art. In a preferred embodiment of the invention, the ethylene homopolymer produced in the tubular reactor has a density of 0.914-0.93 g/cc and the ethylene homopolymer produced in the autoclave reactor has a density of from 0.91-0.94 g/cc. More preferably, the polymer blend of the current invention is composed of ethylene homopolymers each with a density of from 0.914-0.93 g/cc.

The ethylene homopolymers of the current invention preferably have a melt index, I₂ in the range of 3-10 g/10 min as measured according to the procedure of ASTM D-1238. Preferably, the ethylene homopolymer produced in the tubular reactor has a melt index, I₂ from 4-10 g/10 min and the ethylene homopolymer produced in an autoclave reactor has a melt index, I₂ from 3-9 g/10 min.

Polydispersity, also known as molecular weight distribution (MWD), is defined as the weight average molecular weight, M_{w} divided by the number average molecular weight, Mₙ and M_{w}/Mₙ was determined by gel permeation chromatography (GPC)-viscometry. The GPC-viscometry technique was based on the method of ASTM D6474-99 and uses a dual refractometer/viscometer detector system to analyze polymer samples. This approach allows for the online determination of intrinsic viscosities and is well known to those skilled in the art. For purposes of the current invention ethylene homopolymers with a polydispersity of greater than about 5 are preferred. Especially preferred are ethylene homopolymers with a polydispersity of between 8 and 30. The molecular weight of the polymer blends or of the ethylene homopolymer produced in either the autoclave reactor or the tubular reactor can be further described as unimodal, bimodal or multimodal. By using the term “unimodal”, it is meant that the molecular weight distribution can be said to have only one maximum in a molecular weight distribution curve. A molecular weight distribution curve can be generated according to the method of ASTM D6474-99. By using the term “bimodal”, it is meant that the molecular weight distribution can be said to have two maxima in a molecular weight distribution curve. The term “multi-modal” denotes the presence of more than two maxima in such a curve. The ethylene homopolymers of the current invention may have unimodal, bimodal or multimodal molecular weight distributions. In the preferred embodiment of the current invention, the ethylene homopolymer produced in a tubular reactor has a multimodal molecular weight distribution; the ethylene homopolymer produced in an autoclave reactor has at least a bimodal molecular weight distribution; and the polymer blends have a multimodal molecular weight distribution.

The inventive polymer blends, which have good adhesion and neck-in properties at high drawdown rates are especially well suited for use in extrusion coating processes. The extrusion coating process as contemplated by the current invention is a means to coat a substrate with a layer of polymer blend extrudate. The substrate may include articles made of paper, cardboard, foil or other similar materials that are known in the art. The processes of extrusion blending (co-extrusion) and extrusion coating can be combined for the purposes of the current invention.

The inventive polymer blends have a good combination of neck-in and adhesion properties. The neck-in values of the inventive polymers will be from 1.0-7.0 cm, more preferably from 2.0-5.0 cm (at a line speed of 150 ft/min). The neck-in value is defined as one-half of the difference between the width of the polymer at the die opening and the width of the polymer at the take off position. The “take off position” is defined as the point at which the molten polymer contacts the substrate on the chill roll. Neck-in values may be reported for extrusion coatings obtained according to different extrusion coating line speeds as measured in feet per minute. The term “line speed” is the rate at which a polymer extrudate is coated on a substrate and is measured in feet per minute. In the preferred embodiment, the inventive polymer blends have improved neck-in values when compared to ethylene homopolymer produced in a tubular reactor. It will be recognized by one skilled in the art that the measured neck-in values may vary for blends of a given adhesion or drawdown rate due to minor differences in the testing equipment used, the extrusion coating line speeds, the operator procedures and the differences between polymer batches.

The adhesion value of the inventive polymer blends will be greater than 20 psig, more preferably greater than 30 psig (at a line speed of 150 ft/min). Adhesion values are measured according to the method of the Mullen Burst Test based on the method described in ASTM D751, Section 18.3. Adhesion values may be reported for extrusion coatings obtained according to different extrusion coating line speeds as measured in feet per minute. In the preferred embodiment, the inventive polymer blends have improved adhesion values when compared to ethylene homopolymer produced in an autoclave reactor. It will be recognized by one skilled in the art that measured adhesion values may vary for a blend with a given neck-in value or drawdown rate due to minor differences in the testing equipment used, the extrusion coating line speeds, the operator procedures and the differences between polymer batches.

The inventive polymer blends have drawdown rates of up to 1700 ft/min. In a preferred embodiment of the current invention, the polymer blends will have drawdown rates of from 500-1500 ft/min. The term “drawdown” or “drawdown rate” is defined as the maximum line speed during extrusion and is a measure of how fast a polymer can be coated on a substrate.

In another preferred embodiment of the current invention, the ethylene homopolymer produced in the tubular reactor contains no or very low levels of a primary antioxidant. Antioxidants packages for stabilizing polyolefins are well known in the art and commonly include a phenolic and a phosphite compound. Two non-limiting examples of a phenolic and phosphite stabilizer are sold under the trade names IRGANOX 1076 and IRGAFOS 168 respectively. The phenolic compound is sometimes referred to as the “primary” antioxidant. The phosphite compound is sometimes referred to as the “secondary” antioxidant. A general overview of phenol/phosphite stabilizers may be found in Polyolefins 2001—The International Conference on Polyolefins, “Impact of Stabilization Additives on the Controlled Degradation of Polypropylene”, p. 521. In the current invention, low levels of antioxidant provide the unexpected additional benefit of improving neck-in and adhesion characteristics of the ethylene homopolymer produced in the tubular reactor. Preferred levels of antioxidant are from 0-1000 parts per million (ppm). More preferred amounts of antioxidant are from 0-500 ppm, with amounts of from 0-300 ppm being especially preferred.

While not wishing to be bound by theory, antioxidants are at least partially responsible for reduced drawdown and neck-in because they reduce or inhibit resin degradation that occurs during the extrusion coating process. The small amount of degradation typically associated with extrusion coating is beneficial in that it reduces polymer chain entanglement and polymer melt elasticity resulting in improved drawdown and neck-in properties. Degradation during extrusion coating also generates polar moieties on the film surface, which improves adhesion to polar substrates.

The current invention is further described by the following non-limiting examples.

### EXAMPLES

Physical blends of an autoclave ethylene homopolymer and a tubular ethylene homopolymer were prepared by tumble blending pellets of the resins at the desired concentrations then coating the mixture on kraft paper using a 1.5 inch MPM extrusion coating line. The extrusion coating line is equipped with: a screw (standard 1.5 inch diameter screw), a barrel and barrel heater (air cooled barrel with three 600 watt heating zones), a pressure indicator (Dynisco 0 to 5000 psi indicator), a die plate (dieplate with a 20 mesh screen pack), a drive (10 horsepower General Electric drive capable of producing a minimum output of 50 lb/hr polyethylene), an adaptor, and a die (twelve inch slit Flex LD-40 die with a 0.20 inch die gap and three heating zones totaling 7000 Watts) and a laminator/coater. The adaptor is equipped with the following: heaters and controllers (nine heater bands with a total of 4450 Watts), a thermocouple (a melt thermocouple located near the outlet of the adaptor and extending into the resin channel to measure molten polymer temperature) and a valve located in the front end of the adaptor to adjust barrel pressure. The laminator/coater consists of: main rolls (15 inch×15 inch chilled chrome roller and rubber coated chilled pressure roll), a drive (10 horsepower DC General Electric drive capable of producing chill roll speeds from 0-2000 ft/min), a paper roll (equipped with a pneumatic brake system adjustable with a pressure regulator), a wind up unit (speed control via a magnetic clutch system) and a speed indicator (capable of measuring coating line speeds to 5000 ft/min).

The neck-in and adhesion values were determined for film obtained at an extrusion coating line speed of 150 ft/min (Table 1). The drawdown rate for the polymer blends in shown in the table 1 below:

TABLE 1

| Polymer | | | Neck-in | Adhesion | |
|---|---|---|---|---|---|
| Blend | Tubular | Autoclave | at (cm) | (psig) at | Drawdown |
| No. | (wt %) | (wt %) | 150 ft/min | 150 ft/min | (ft./min.) |
| 1 | 100 | 0 | 6.98 | 46.0 | 1480 |
| 2 | 70 | 30 | 3.78 | 37.0 | 1027 |
| 3 | 50 | 50 | 2.88 | 36.0 | 718 |
| 4 | 30 | 70 | 2.18 | 38.8 | 566 |
| 5 | 0 | 100 | 2.29 | 17.8 | 551 |

The data in Table 1 illustrate that increasing the weight percent (wt %) of tubular ethylene homopolymer in the polymer blend improves the adhesion and drawdown values. Conversely, increasing the wt % of autoclave ethylene homopolymer in the polymer blend improves the neck-in values.

Table 2 illustrates the effect of antioxidant levels on the extrusion coating properties of the ethylene homopolymer produced in a tubular reactor. The data provided in Table 2 were obtained using a different batch of tubular ethylene homopolymer to that used in the blends. Testing conditions for acquiring the data provided in Table 2 were similar, but not identical to those used to obtain the data provided in Table 1. The data show that low neck-in and high adhesion values are obtained at low levels of antioxidant, particularly at levels below 500 ppm. The antioxidants used comprise a 1:1 blend of Irganox 1076 primary phenolic antioxidant and Doverfos S-9228 secondary phosphite. Antioxidants were compounded into a sample of the ethylene homopolymer produced in a tubular reactor to produce a masterbatch. That masterbatch was dry-blended into the same product at appropriate levels to produce the final additive concentrations shown in Table 2.

TABLE 2

| Antioxidant | | NI @ | Drawdown | Adhesion |
|---|---|---|---|---|
| Concentration, | NI @ (cm) | Drawdown | Speed | (psig) at |
| (ppm) | 150 ft/min | (cm) | (ft/min) | 150 ft/min |
| 0 | 8.2 | 5.1 | 1683 | 15.5 |
| 100 | 8.8 | 5.4 | 1500 | 16.7 |
| 250 | 9.4 | 5.3 | 1450 | 15.5 |
| 500 | 9.7 | 5.8 | 1378 | 14.8 |
| 1000 | 9.8 | 5.8 | 1333 | 10.9 |
| 2000 | 10 | 5.8 | 1330 | 9.5 |

What is claimed is:

1. A polymer blend comprising:
75-25 wt % of an ethylene homopolymer produced in a tubular reactor and
25-75 wt % of an ethylene homopolymer produced in a stirred autoclave reactor;
provided that
the ethylene homopolymer produced in each reactor is removed from the reaction zone prior to being blending together.

2. A polymer blend according to claim 1, wherein the ethylene homopolymer produced in a tubular reactor has a melt index, I₂ of 4-10 g/10 min and the ethylene homopolymer produced in a stirred autoclave reactor has of a melt index, I₂ of from 3-9 g/10 min.

3. A polymer blend according to claim 2, wherein the ethylene homopolymer produced in a tubular reactor and the ethylene homopolymer produced in the autoclave reactor have densities of from 0.914 to 0.93 g/cc.

4. A polymer blend according to claim 3, wherein the ethylene homopolymer produced in a tubular reactor has a polydispersity, M_{w}/Mₙ of 8 or more and the ethylene homopolymer produced in a stirred autoclave reactor has a polydispersity, M_{w}/Mₙ of at least 10.

5. A polymer blend according to claim 4 which has a neck-in value of 2.0-5.0 cm at a line speed of 150 ft/min.

6. A polymer blend according to claim 5, wherein the ethylene homopolymer produced in a tubular reactor contains 0-500 ppm of an antioxidant.

7. A polymer blend according to claim 6, which has a melt index, I₂ of 4-10.

8. A polymer blend according to claim 7, which has a polydispersity, M_{w}/Mₙ of 10 or more.

9. An extrusion coating process characterized in that said process comprises coating a substrate with a polymer blend comprising:
75-25 wt % of an ethylene homopolymer produced in a tubular reactor and
25-75 wt % of an ethylene homopolymer produced in a stirred autoclave reactor;
provided that,
the ethylene homopolymer produced in each reactor is removed from the reaction zone prior to being blending together.

10. An extrusion coating process according to claim 9, wherein the ethylene homopolymer produced in a tubular reactor, has a density of 0.914-0.930 g/cc and the ethylene homopolymer produced in a stirred autoclave reactor has a density of 0.914-0.930 g/cc.

11. An extrusion coating process according to claim 10, wherein the ethylene homopolymer produced in a tubular reactor has a melt index, I₂ of 4-10 g/10 min and the ethylene homopolymer, produced in a stirred autoclave reactor has a melt index, I₂ of 3-9 g/10 min.

12. An extrusion coating process according to claim 11, wherein the ethylene homopolymer produced in a tubular reactor contains 0-500 ppm of an antioxidant.

13. An extrusion coating process according to claim 12, wherein the ethylene homopolymer produced in a tubular reactor has a polydispersity, M_{w}/Mₙ of 8 or more, and the ethylene homopolymer produced in a stirred autoclave reactor has a polydispersity, M_{w}/Mₙ of at least 10.

14. An extrusion coating process according to claim 13, wherein the polymer blend has a neck-in value of 2.0-5.0 cm at a line speed of 150 ft/min.

15. An extrusion coating process according to claim 14, wherein the polymer blend has a melt index of 4-10 g/10 min.

16. An extrusion coating process according to claim 15, wherein the polymer blend has a polydispersity, M_{w}/Mₙ of 10 or more.

17. A polymer blend comprising:
70-40 wt % of an ethylene homopolymer, which is produced in a tubular reactor, and which has a melt index, I₂ of from 4 to 10 g/10 min and which contains 0-500 ppm of an antioxidant and
30-60 wt % of an ethylene homopolymer, which is produced in a stirred autoclave reactor, and which has a melt index, I₂ of from 3-9 g/10 min;
provided that,
the ethylene homopolymer produced in each reactor is removed from the reaction zone prior to being blending together.

18. An extrusion coating process characterized in that said process comprises coating a substrate with a polymer blend comprising:
70-40 wt % of an ethylene homopolymer, which is produced in a tubular reactor, and which has a melt index, I₂ of from 4-10 g/10 min and which contains 0-500 ppm of an antioxidant and
30-60 wt % of an ethylene homopolymer, which is produced in a stirred autoclave reactor, and which has a melt index, I₂ of from 3-9 g/10 min;
provided that,
the ethylene homopolymer produced in each reactor is removed from the reaction zone prior to being blending together.

19. An extrusion coating process according to claim 18, wherein the ethylene homopolymer produced in a tubular reactor, has a density of 0.914-0.930 g/cc and the ethylene homopolymer produced in a stirred autoclave reactor has a density of 0.914-0.930 g/cc.

20. An extrusion coating process according to claim 19, wherein the ethylene homopolymer produced in a tubular reactor has a polydispersity, M_{w}/Mₙ of 8 or more and the ethylene homopolymer produced in a stirred autoclave reactor has a polydispersity, M_{w}/Mₙ of at least 10.

21. An extrusion coating process according to claim 20, wherein the polymer blend has a neck-in value of 2.0-5.0 cm at a line speed of 150 ft/min.

22. An extrusion coating process according to claim 21, wherein the polymer blend has a melt index, I₂ of 4-10 g/10 min and a polydispersity, M_{w}/Mₙ of 10 or more.
